(19) United States
(12) Patent Application Publication
(10) Pub. No.: US 2021/0133903 A1
(43) Pub. Date: May 6, 2021

(54) DIGITIZED CONTRACT GENERATION WITH COLOCATION SECURITY

(71) Applicant: VOLENDAY LLC, Houston, TX (US)

(72) Inventor: James Larry Poole, III, Katy, TX (US)

(21) Appl. No.: 17/119,048

(22) Filed: Dec. 11, 2020

Related U.S. Application Data
(63) Continuation of application No. PCT/US2020/017886, filed on Feb. 12, 2020.
(60) Provisional application No. 62/804,572, filed on Feb. 12, 2019.

(51) Int. Cl. G06Q 50/18; G06Q 10/06; G06F 16/23; G06F 40/166

(52) U.S. Cl. CPC G06Q 50/188; G06Q 10/067; G06Q 2220/18; G06F 40/166; G06F 16/2308

(57) ABSTRACT

Disclosed computer systems implement techniques for digital document management for collaboration and multi-party manipulation of contents of a digital document. The disclosed collaboration system utilizes a colocation area (e.g., logical or physical shared repository or work area) with enhanced security and tracking (e.g., change identification) capabilities. Role based access to the colocation area and to specific portions of the digital document may be utilized. Accordingly, updates are maintained in a secure and identifiable manner for all parties to the collaboration. Each party to the collaboration may be restricted with respect to visibility or changes that are not consistent with their currently defined role (e.g, vendor, supplier, customer, administrator, lawyer). Disclosed techniques may be applicable to any type of digital document collaboration and may be specifically useful for digital document negotiations that may take place when multiple parties are forming an agreement (e.g, contract for products or services).

### RELATED APPLICATIONS

This application claims priority (and all applicable rights) to U.S. Provisional Application No. 62/804,572 filed Feb. 12, 2019, having the same title and inventorship as the instant application.

### BACKGROUND

Document management systems are computer based systems to manage contents of digital files representing documents. Typical computer systems manage an entire digital document as a whole (i.e., as a single computer file representing the entire document). When managed as a single document, changes made to the digital document may be obfuscated by the other information in the digital document. That is, the digital document may contain many parameters and parts that are all independently important in providing for what the digital document as a whole represents. Previous digital document management systems manage the digital document as a single entity without modularity for review/approval and security.

In previously available implementations of document management systems, for example, a digital contract document may be created using a conventional word processing software, such as MICROSOFT WORD®, and transmitted back and forth between parties via electronic mail. Collaboration techniques have been developed to allow document sharing. See, e.g., U.S. Pat. Nos. 9,875,221, 9,699,409, 9,613,340, 9,306,941, 9,137,220, and 2015/0350690. For highly confidential documents, techniques have also been developed to secure documents. See, e.g., U.S. Patent Application Nos. 2017/0237569 and 2017/0243193.

Despite advances in document creation, sharing, and security, there remains a need for techniques that allow parties to more efficiently and securely manage contracts, identify changes to documents, protect modification to different subsections to ensure that only authorized parties are allowed to alter appropriate subsections, and more efficiently manage contents of the document (e.g., digital document used as part of a digital document negotiation). Prior art systems may allow for a template that only allows modifications to “blanks” (e.g., specific fields of data entry) in the template.

### BRIEF DESCRIPTION OF THE DRAWINGS

So that the above recited features and advantages of the present disclosure can be understood in detail, a more particular description of the disclosed improvements, briefly summarized above, may be had by reference to the embodiments thereof that are illustrated in the appended drawings. The appended drawings illustrate example embodiments and are, therefore, not to be considered limiting of its scope. The figures are not necessarily to scale and certain features, and certain views of the figures may be shown exaggerated in scale or in schematic in the interest of clarity and conciseness.

FIG. 1 is a schematic diagram depicting one example digitized contract generation system in accordance with disclosed implementations.

FIG. 2 illustrates an example computer network that may be used to implement the digitized contract generation system of FIG. 1 or other disclosed implementations.

FIGS. 3A-3L illustrate example computer screen shots of example implementations of the disclosed digitized contract generation system.

FIG. 4 illustrates a schematic diagram depicting a possible processing flow of a computer system when finalizing (e.g., authenticating an initial agreement or amendment) for a digitized contract maintained within a computer system built in accordance with this disclosure.

FIG. 5 illustrates a schematic diagram depicting a possible processing flow of a computer system when performing a colocation digital document negotiation and securing a digitized contract maintained within a computer system built in accordance with this disclosure.

FIG. 6 illustrates a first example method for processing a digital document negotiation in accordance with examples of this disclosure.

FIG. 7 illustrates a computing device including computer instructions to perform the example method of FIG. 6 in accordance with examples of this disclosure.

FIG. 8 illustrates an example distributed computing system that may be used to implement the methods, processes, and techniques of this disclosure.

FIG. 9 illustrates an example computing device that may be used to implement the methods, processes, and techniques of this disclosure.

### DETAILED DESCRIPTION

The description that follows includes exemplary systems, apparatuses, methods, and instruction sequences that embody techniques of the subject matter herein. However, it is understood that the described embodiments may be practiced without these specific details.

This disclosure presents a system that allows enhanced tracking, modification, security, and authorization for each step of a digital document negotiation. More particularly, the disclosure relates to a digitized contract generation system (“contract system”) that has attributes to allow modular control over discrete (but related) aspects of an agreement. The embodiments of the disclosed contract system may provide specific improvements that may be applicable to software license agreements. Although, the implementation examples of this disclosure are explained with respect to techniques that focus on software license agreements, the disclosed techniques may be applicable in other contexts as well. Thus, the disclosed computer system to facilitate a digital negotiation process is not limited to management of software license agreements.

In a business context, parties negotiate agreements with different parameters to establish a mutual set of legally binding promises, and to recognize agreed upon rights and duties between the parties. This negotiation may culminate and be recorded in a legal contract. The contract may be in written form with a list of terms that sets forth such rights and duties. This list of terms may relate to a specific subsection of the agreement and corresponding digital document. The parties may adjust and revise these terms through negotiations until the final terms are accepted by both parties. These final terms may be acknowledged by signature of the written contract by both parties. The signature confirms their agreement to abide by such negotiated terms. One type of contract relates to software license agreements between software vendors and customers. In a software license agreement, there may be aspects of the agreement that are not common to other types of contracts and thus may benefit from a more automated “digital negotiation process” as described herein.

This disclosure explains various techniques that have been developed for handling digital document negotiations between parties. In this context, the term “digital document negotiations” refers to the iterative nature of applying changes to a document and providing information about those changes to all interested parties (e.g., parties to an agreement for products, services, etc.). A final step of a digital document negotiation may be to solicit agreement with respect to the sum of changes made throughout the negotiation. In a typical negotiation process, there may be many iterations and each iteration may include changes to one or more subsections (e.g., list of terms, rights, and duties). An understanding and tracking of changes made by each party at each iteration may be important. This understanding may be improved by a computer system designed with enhanced tracking and notification capabilities such as the system disclosed herein.

In general, the disclosed document management system provides a secure and centralized facility, namely a contract colocation, where contracts between parties are digitally processed (e.g., created, altered, reviewed, edited, finalized, approved, signed, and/or secured). Unlike existing techniques that may require entire documents to be passed back and forth over communication networks using document editing software, this contract system allows users to enter the contract colocation to work on the same contract (or specific portions thereof based on roles as will be explained below) within the secure contract colocation. The colocation area may be implemented using a single, perhaps cloud-based, storage repository or may be implemented in multiple discrete repositories with the colocation aspect being implemented logically rather than physically. In any case, regardless of the implementation, a user may be presented an interface to the applicable portions of the contract based on their role and actions needed at a specific phase (e.g., based on a state machine as discussed below).

In some implementations, documents are made up of different parts (e.g., subsections) that collectively form the entire document. Each of these subsections may be stored as independent computer files that are, via security considerations, accessible to different parties to the agreement at different phases of the negotiation process. Further, each of the different parties may designate individuals (e.g., based on their role in the process) to comment, update, and/or approve different subsections at each of the different phases. In technical terms, this may be thought of as each subsection of a document progressing through a state machine applicable to that subsection. Accordingly, implementations may utilize multiple state machines, controlled by software executing on a computer system, to manage a life-cycle for each subsection (i.e., subsection life-cycle) of a document and the agreement as a whole (i.e., document life-cycle).

In general, a first party may be able to access and interact with a first subset of a set of subsections, and a second party may be able to access and interact with a second subset of subsections (different than the first subset). Once each subsection has been “approved” internally for a party (e.g., completed a subsection life-cycle), that “completed” subsection may be made visible to all users. This process of security and visibility may be repeated for all subsections such that, upon final approval (prior to signature), all parties may have read-only access to all subsections and thus the document as a whole. Next, a sign-off process may complete the digital negotiation process. In some implementations, each subset may be controlled as an individual computer file and logically concatenated to form the whole document.

In one example, a first state machine may be implemented to reflect a subsection life-cycle of a specific subsection of a digital document. A second state machine may be implemented to reflect a different subsection life-cycle for a different subsection (i.e., each subsection may have its own life-cycle). A document state machine may be implemented to reflect the document life-cycle of the document as a whole. Each of these different state machines may be implemented using a directed graph processed by a computer system to control access to, and approval of, their respective portions of the document through a digital negotiation process. States may be represented as nodes of the directed graph. Transitions from one node to the next (e.g., state transitions) may be based on actions taken by users and controlled based on user roles and user access to each document portion at each node (e.g., layered security).

The disclosed contract system provides a centralized contracting structure to: designate users (e.g., reviewers, authorized signatories, etc.), enter contracting parameters (e.g., party information, defined terms, pricing, etc.), monitor activity on the contract document (e.g., edits, comments, approvals, etc.), digitally sign the contract (e.g., with digital signatures and public/private keys), and secure the contract (e.g., validate, identify, and digitize). Each party to the contract may designate users to receive notifications of status changes to assigned contracts (subsections), and to receive alerts to enter the contract colocation to act on such contracts (subsections). Further, the disclosed process does not terminate when an agreement is initially reached and allows for amendments to be made throughout the term of any agreement. For example, a customer may negotiate an initial purchase of a number of software licenses for an organization. Over time, the organization may require additional (or fewer) licenses for the original products or other products. The disclosed contract system facilitates these changing business needs by allowing alterations (e.g., amendments) under the terms of the originally agreed purchase contract.

The contract system also provides multi-layered security to restrict access to the colocation, and to define credentials (e.g., passwords, keys, timestamps, etc.) relating the parties and their contracts that must be verified before the contract (or portion thereof) may be accessed. Verification is performed by designated users familiar with the contract and the parties, and by the contract system with the ability to verify credentials. This multi-layered security also includes digital verification for signing the contract, and digital coding (i.e. digital fingerprint or hash) of the contract itself. The contract is converted from a readable document format into a digital format (e.g., a hash) that provides a digital translation of the contract into a secure numeric code accessible only by authorized users with matching encryption keys. For added security, information may be stored in a distributed transaction ledger (“DTL”) such as blockchain that allows for unalterable information to be stored across a plurality of servers providing consensus with respect to accurate leger entries (e.g., blocks in a blockchain).

The disclosed contract system, may be implemented to provide one or more of the following features: centralized processing of contracts, efficient review/revision, records of revisions and comments, notice of revisions, designated user access levels (e.g., for reviewers/approvers/signatories), secured access to contracts, digitized record of the contract, multiple layers of access to and storage of contracts (or portions thereof), ability to import or access existing terms, a tracking system for contract review/revision, simplified contract creation, storage of user parameters (e.g., contact info, restricted access, review/approval permissions, etc.), storage of contract parameters (e.g., contract terms, contract access, contract processing, etc.), etc. In one example, an import feature allows users to import information (e.g., from structured files or information discovered on a network) to automatically populate information within the contract system. Specifically, a vendor may provide information in an import file to describe available software offerings from that vendor. As a second example, a customer may run a discovery process on their network to determine a current usage level of software products (e.g., for audit and compliance) and make that information accessible to the disclosed contract system. Each of the disclosed import functions may be automated by either the vendor or the customer (e.g., to run periodically).

### Contract System Structure

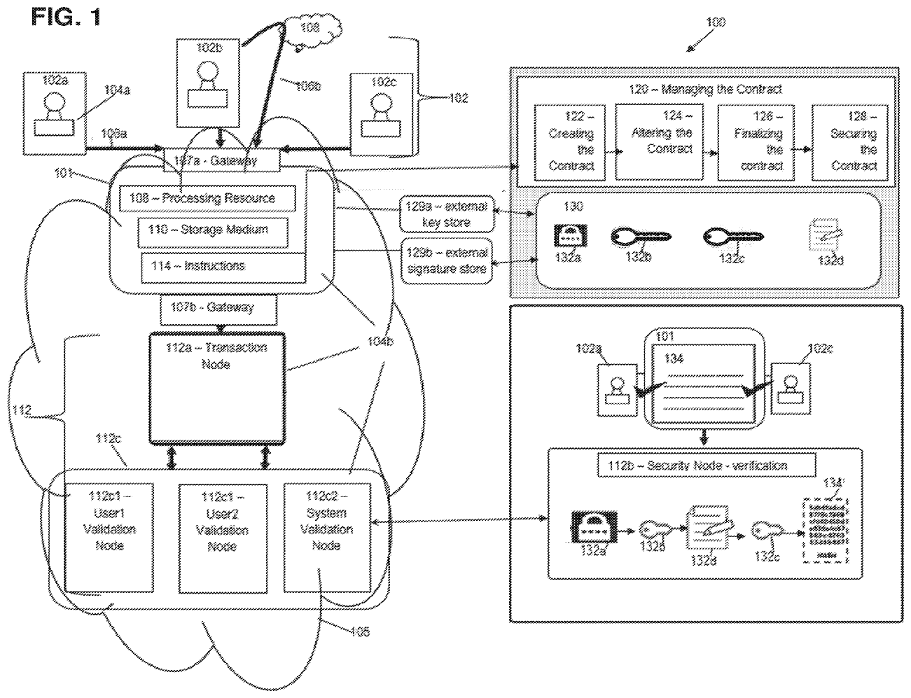

FIG. 1 is a schematic diagram depicting one example document management system (DMS) depicted in an example implementation of a contract system 100 for processing contracts between parties (e.g., performing a digital negotiation process as disclosed for a contract). Contract system 100 may be a centralized system defining a colocation 101 accessible by one or more users 102 designated by the parties. Such users 102 as depicted represent one or more persons. In the example shown, users 102 include a vendor 102a, a vendor 102b, and a client 102c. Each of the vendors 102a,b seek to enter into a contract with client 102c. As mentioned above, colocation 101 may be a physically centralized system or may be implemented on physically different systems that are logically controlled as colocation 101.

Users 102 may be located at various locations, and have one or more computing devices (e.g., computers) 104a capable of communicating with contract system 100. As used herein, a “computing device” may be a server, computer networking device, include a specialized chip set, desktop computer, workstation, or any other processing device or equipment, such as a server that interfaces with a remote network hardware, such as a source node switch. Computing devices 104a may be, for example, conventional computers with associated hardware (e.g., processors, databases, servers, displays, mice, keyboards, etc.) that may be specifically configured through software to allow users 102 to access contract system 100 to generate contracts (or perform amendments to existing contracts or sub-sections thereof).

In this example, computing devices 104a access contract system 100 via a communication link 106a,b. Each communication link 106a,b may be a wired, wireless, satellite, local, remote or other type of communication link (e.g., electrical cable such as Ethernet, optical fibers, radio waves, etc.) capable of transmitting data between users 102 and contract system 100. For example, each communication link may be a direct link 106a between user 102 and colocation 101. In another example, the communication link may be an indirect link 106b extending from user 102b through a cloud structure 108 (e.g., remote connectivity connection) and to colocation 101. Users 102 may access colocation 101 via a gateway 107a. Gateway 107a may be a restricted access gateway, using a password authenticator, public key infrastructure (PKI), or other security means for selectively permitting specified users 102 to access contract system 100.

Contract system 100 may include one or more computing devices 104b housed on a network 105. Computing devices 104b may include colocation 101 and nodes 112 (e.g., transaction node(s) 112a, validation nodes 112c, and security nodes 112b). Colocation 101 may communicate with nodes 112 and users 102 via network 105. Network 105 may provide a communication pathway between computing devices 104a,b, at least one data linkage (e.g., communication links 106a,b), or a combination thereof to allow the communication and exchange of data between computing device(s) 104a,b. Network 105 may also include intermediary computing devices between computing devices 104a,b. In some examples, network 105 may be an individual network or a collection of many such individual networks interconnected with each other and functioning as a single large network (e.g., an intranet). In some examples, network 105 may be implemented as a local area network (LAN), wide area network (WAN), etc.

Colocation 101 includes a processing resource 108 (sometimes referred to as a computer processor) connected by network 105 to a storage medium 110. Processing resource 108 may be, for example, in the form of a central processing unit (CPU), a semiconductor-based microprocessor, a digital signal processor (DSP) such as a digital image processing unit, other hardware devices or processing elements suitable to retrieve and execute instructions stored in a storage medium, or suitable combinations thereof. The processing resource can be functional to fetch, decode, and execute instructions as described further herein.

Storage medium 110 may be in the form of non-transitory machine-readable storage medium, such as suitable electronic, magnetic, optical, or other physical storage apparatus to contain or store information such as instructions 114. Storage medium 110 may be located at colocation 101 as shown, or in one or more locations through contract system 100. Storage medium 110 may be a machine-readable storage medium capable of receiving and storing data. Storage medium 110 may include one or more storage facilities for storing various forms of data received or generated in contract system 100. For example, storage medium 110 may include one or more storage facilities for housing contract terms, party information, contract parameters, security protocols, etc.

In the example of FIG. 1, instructions 114 are stored (encoded) on storage medium 110 and are executable by processing resource 108 to implement functionalities described herein. In some examples, storage medium 110 may include additional instructions, such as instructions to implement some of the functionalities described in relation to nodes 112. In other examples, the functionalities of any of the instructions of storage medium 110 may be implemented in the form of electronic circuitry, in the form of executable instructions encoded on machine-readable storage medium, or a combination thereof.

As schematically shown in FIG. 1, colocation 101 may be used to implement instructions 114 for 120—managing the contract (e.g., a computer functional module to perform management of contract functions). Such managing 120 may involve additional functional modules for 122—creating the contract, 124—altering (reviewing/approving/amending) the contract, 126—verifying (signing) the contract, and 128—securing the contract (e.g., using role based security) as is described further herein. Creating 122 and altering 124 functions may be performed from within colocation 101. The 126 signing and 128 securing functions may be performed in combination with nodes 112 and external sources 129a,b.

Contract colocation 101 may be used in combination with the internal and/or external services to generate security credentials 130. These security credentials 130, may include a secure password 132a, a public key 132b, a private key 132c, a digital signature 132d, and other means for authentication as schematically shown. Security credentials 130 are used in combination with nodes 112 to restrict access and to secure the contract, thereby providing multi-layered security as is described further herein. Security credentials 130 are also used to create a digital fingerprint (hash) for the contract as is described further herein.

As schematically, shown, security credentials 130 may be provided using external services 129a,129b. These external services 129a,b may be accessed by colocation 101 and implemented external to contract system 100. By accessing external services 129a,b, the encryption keys 132b,c and digital signatures 132d may be secured, created, and maintained externally to colocation 101. Having external services may assist to isolate exposure of secure information associated with security credentials 130.

External services 129a,b may include, for example, an external keystore 129a for generating each of security keys 132b,c and external signature store 129b for generating digital signatures 132d. Keystore 129a may be any keystore capable of defining an encrypted keys for users 102, such as ETHERIUM® or www.walleth.org. In another example, key service 129b may be any service capable of generating digital signatures for the users, such as DOCUSIGN® (commercially available at www.docusign.com) or GLOBALSIGN® (commercially available at www.globalsign.com). A digital certificate associated with digital signature 132d may be uploaded into colocation 101, linked to a user profile within the system, and assigned a corresponding password. User 102 may use this password to sign with the digital certificate as is described further herein.

Colocation 101 may be coupled to nodes 112 for operation therewith. A gateway 107b may be provided to restrict access to nodes 112. Gateway 107b may employ a validator (e.g., ETHERIUM®) to require proof of authority (authentication) before nodes 112 may be accessed. The proof of authority may include, for example, verification of system credentials, such as a timestamp, public address, transaction ID, and/or verification of one or more of security credentials 130.

Nodes 112 as shown include a transaction node 112a, a security node 112b (that may include a blockchain or other distributed transaction ledger implementation), and validation nodes 112c. Each of the nodes 112a-c may be in the form of one or more computing devices 104b coupled to colocation 101 via network 105. Each of these nodes 112 are used to further process contracts 134 (or sub-sections thereof based on role) generated within colocation 101 using processing resource 108, storage medium 110, and instructions 114. These nodes 112a-c2 may be used to validate users 102 using transaction node 112a, secure contract 134 using security node 112b, and validate contract 134 using validation node 112c. Validation nodes 112c may include a system validation node 112c2 and one or more user (peer) validation nodes 112c1. Each validation node 112c1 may correspond to one of users 102a-c.

As schematically shown, once contract 134 is created, it is made available at transaction node 112a (e.g., it is uploaded over the network). Transaction node 112a captures contract 134 (or sub-section thereof) created/updated at colocation 101, and broadcasts contract 134 to validation nodes 112c. In this example, transaction node 112a acts as a communication gateway to validation nodes 112c, and validation nodes 112c are used to confirm contract 134. Validation by a predetermined amount (e.g., 50%) validation of the validation nodes 112c may be required before a contract 134 may proceed to signature (e.g., a consensus validation may take place across multiple nodes). Such validation may involve verification of the security credentials 130.

Once validated, contract 134 may be passed to security node 112b and processed for signature. Security node 112b may require identification of one or more of security credentials 130 before a signature may be processed. In the example shown, security node 112b determines a proper password 132a, public key 132b, digital signature 132d, and private key 132c before contract 134 may be validated. Once complete, contract 134 may be digitized into a digital contract 134′. To be clear, in the above example the system may process either a complete contract 134 or a portion thereof (e.g., sub-section) for any of the above mentioned processing steps. In an amendment (update to contract) process, only selected sub-sections may be affected by each amendment.

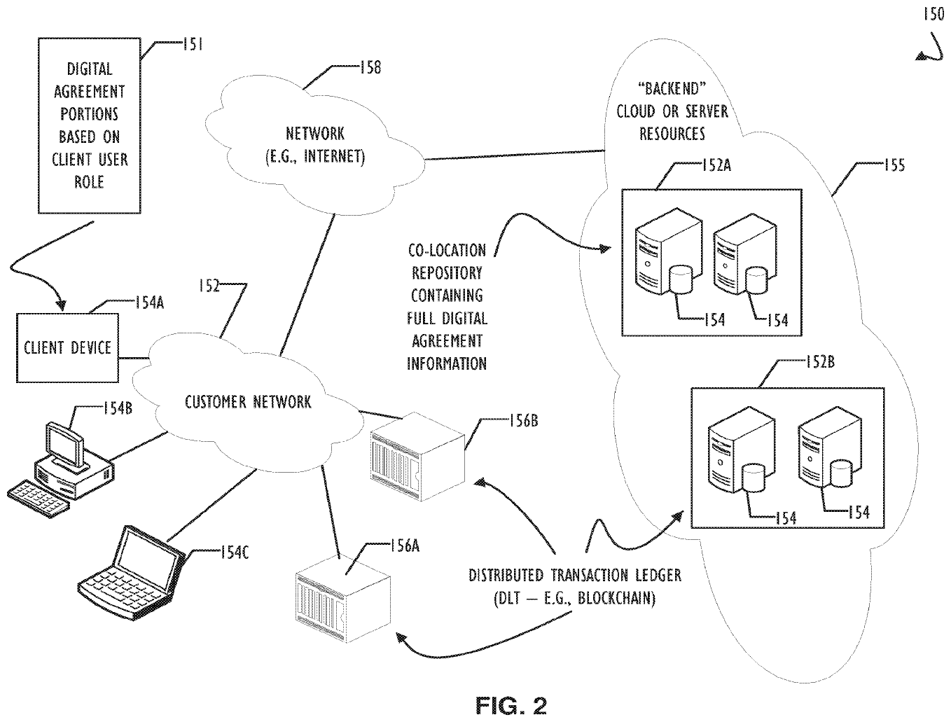

Referring to FIG. 2, a second example distributed computer system 150 is illustrated. In this example, a digital agreement 151 (or portions thereof) may be made available (e.g., from a colocation area such as colocation 101 of FIG. 1) on a client device (e.g., client device 154A). The portions of the digital agreement 151 may be made available based on a state of a digital negotiation process and a role of a user associated with a particular client device. Different types of client devices may interface throughout a digital negotiation process. For example, a desktop computer 154B or a laptop 154C may be used by a user. Client device 154A represents a generic client device and may include a smart phone, tablet, or other type of computing device with a user interface.

Each of client devices 154 may be connected to customer network 152 to interface (e.g., via network 158 which may be the Internet) with backend or cloud resources 155 and other computer systems connected via network links. In this example, customer network 152 includes compute resources 156A,B that are illustrated to participate in a distributed transaction ledger (DTL) security implementation (e.g., a blockchain implementation). Backend or cloud resources 155 includes multiple servers 154 that may be used to host a colocation repository (and perform colocation functionality) as illustrated for servers 152A. Backend or cloud resources 155 further includes servers 152B that may additionally provide DTL security. From the perspective of users, network attached backend servers (e.g., backend cloud or server resources 155) appear as functionally discrete systems. Each of these functionally discrete systems may be implemented on either physical hardware or may be implemented using virtual machines (VMs).

As mentioned above, roles may be assigned to different users and used to determine accessibility and action permissions for a designated user at a point in the life-cycle (e.g., state) of a digital negotiation process. In one implementation, roles include: Client Author, Client Reviewer, Client Signatory, Vendor Author, Vendor Reviewer, and Vendor Signatory. Each of these roles, for one example implementation, may be implemented as described next (other capabilities may also be designated based on roles).

The Client Author can create/initiate the contract process within the disclosed system. The author serves as the focal point of the process to submit contract information to vendors and assign Reviewers & Signatories from the client side. The Client Reviewers are internal approvers within an organization that help Authors review contract terms and conditions. The Client Reviewers only have read access to contracts and the ability to approve sections. The Client Signatory is the final reviewer with the authority to signoff contractual agreements. The Vendor Author can create/initiate the contract process within the disclosed system. The author serves as the focal point of the process to submit contract information to clients and assign Reviewers & Signatories from the vendor side. The Vendor Reviewers are internal approvers within an organization that help Authors review contract terms and conditions. The Client Reviewers only have read access to contracts and the ability to approve sections. The Vendor Signatory is the final reviewer with the authority to signoff contractual agreements within the disclosed system.

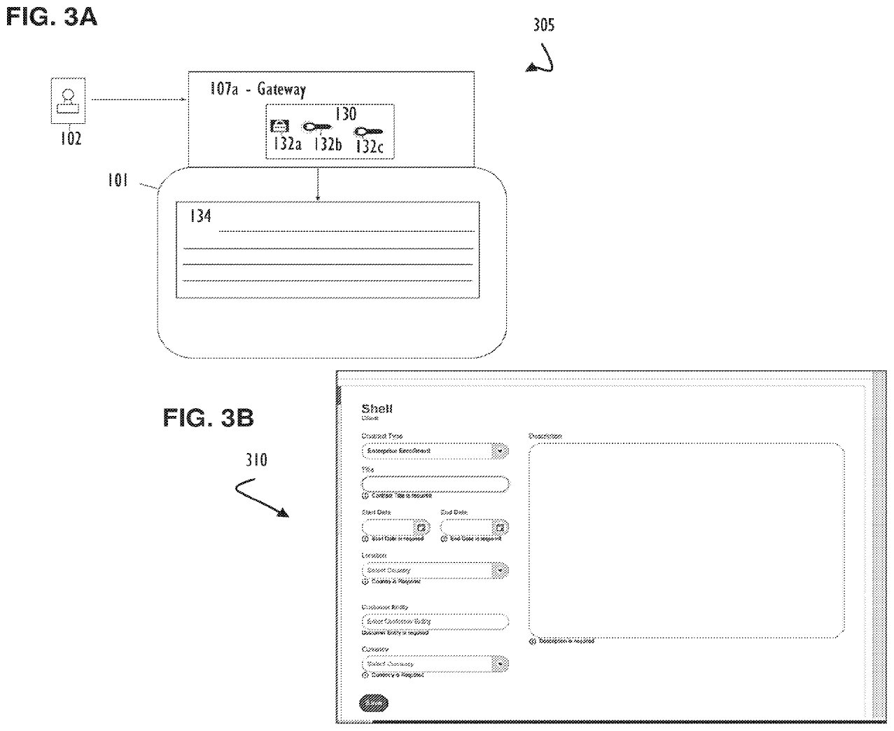

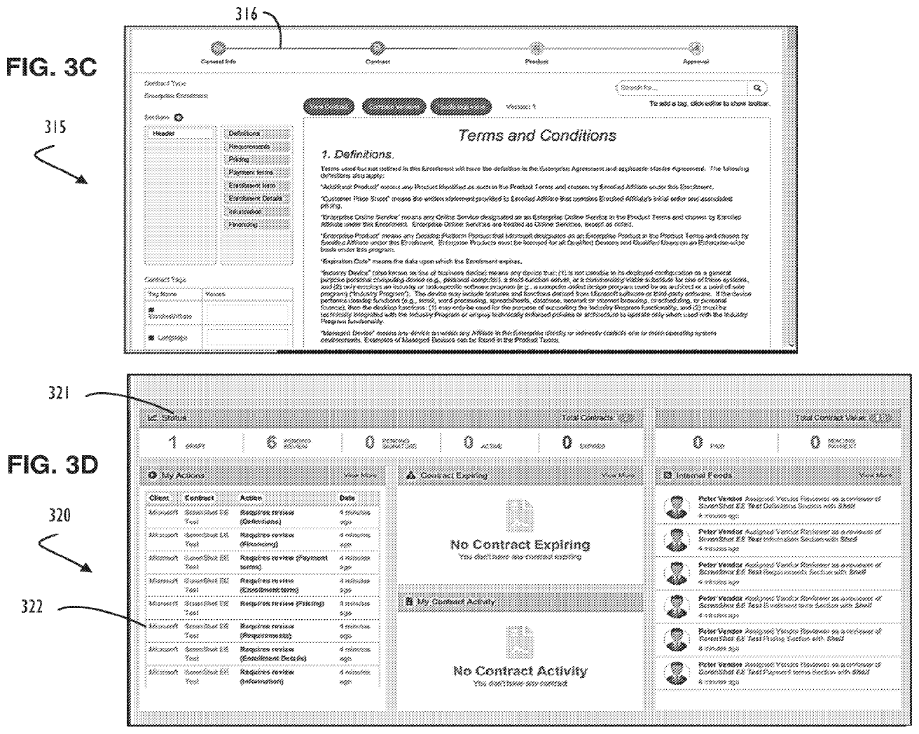

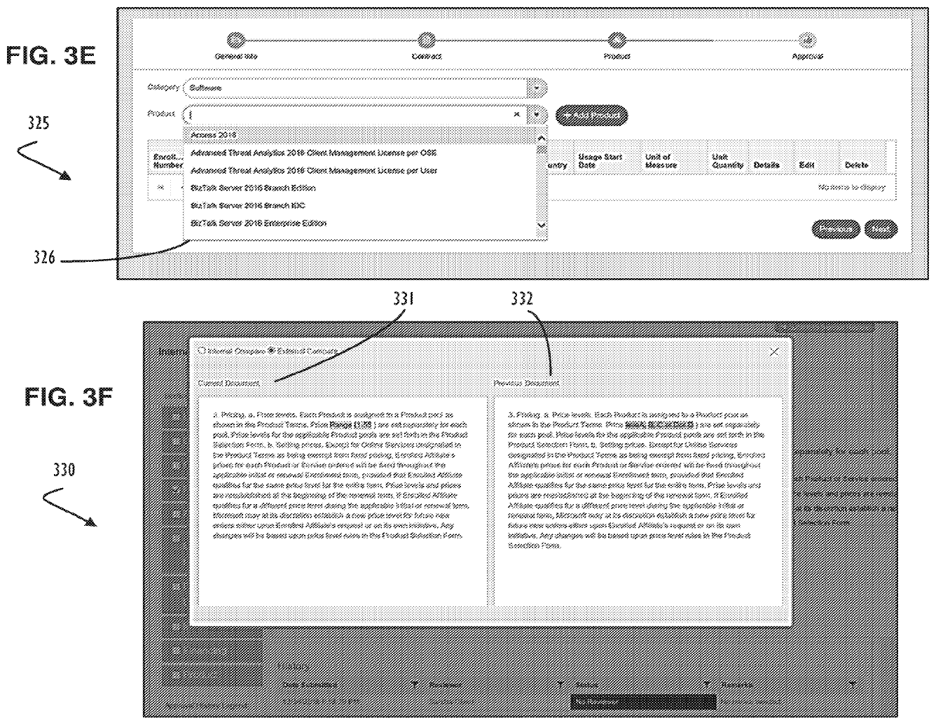

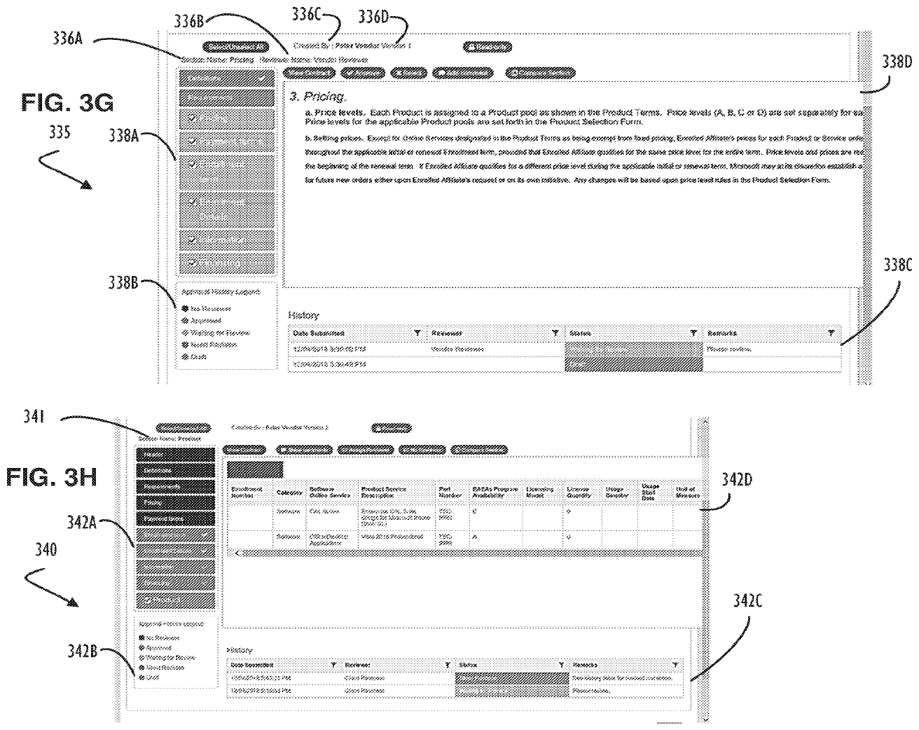

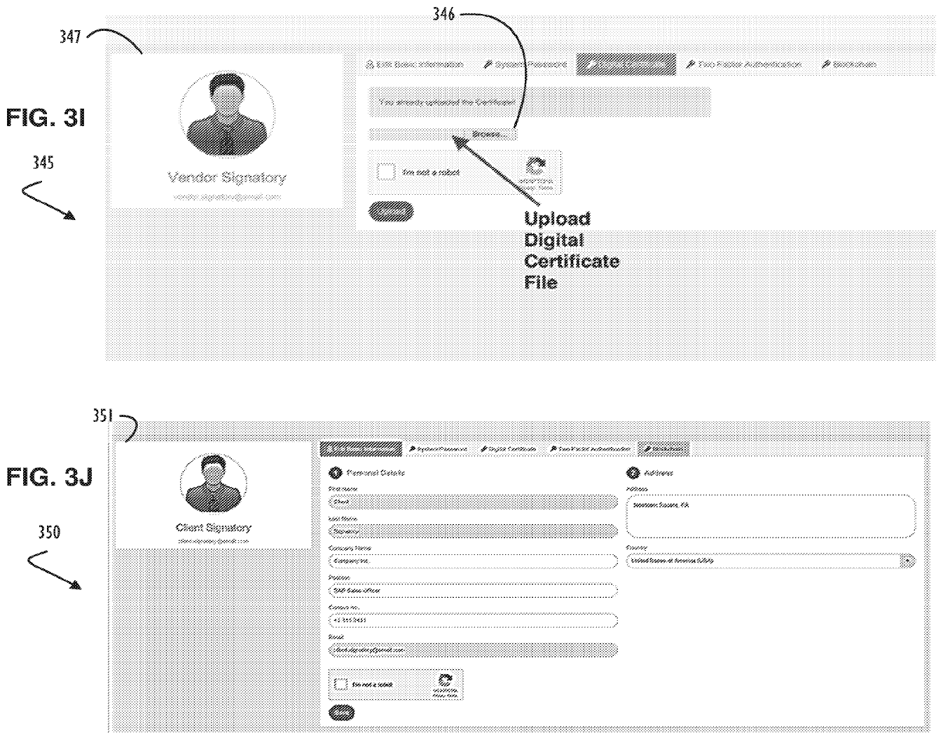

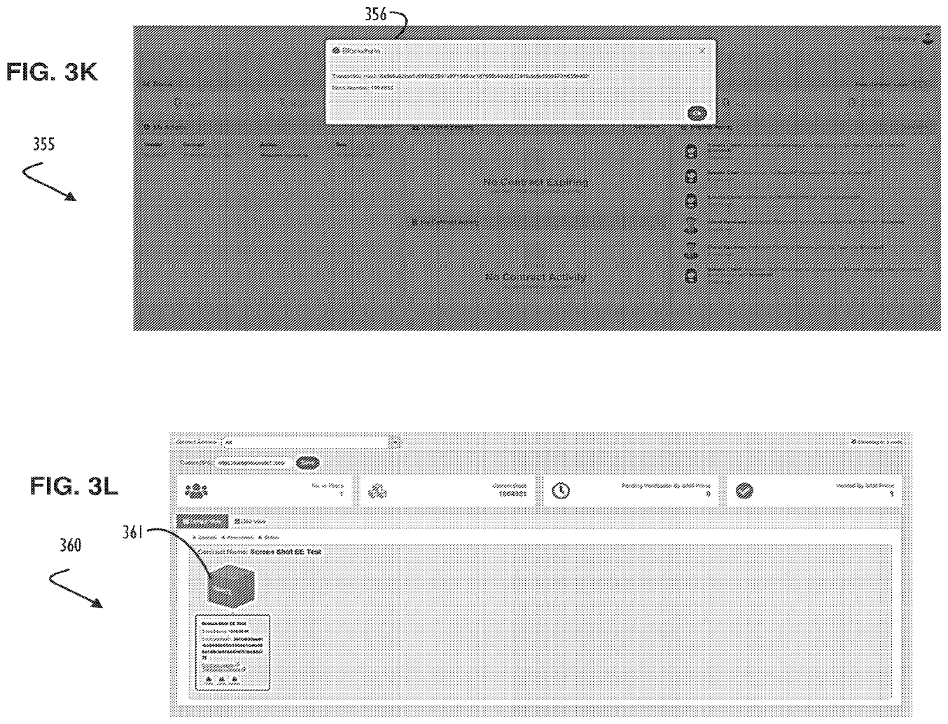

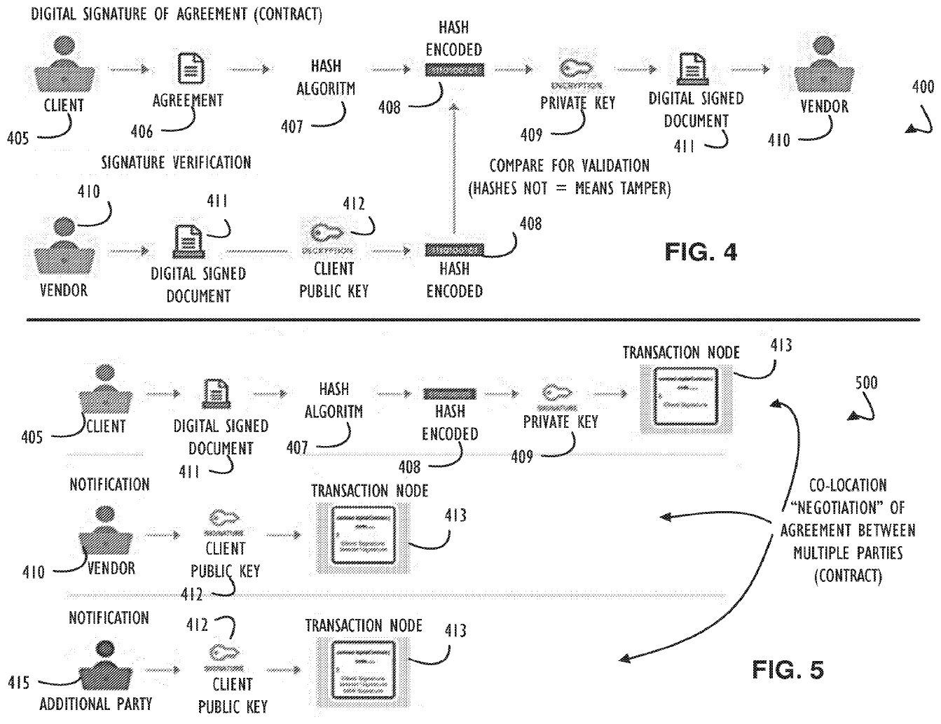

Referring now to FIGS. 3A, and 3B-L, in which FIG. 3A illustrates schematic view 305 and 3B-L illustrate different screen shots are illustrated as might be presented as part of a user interface (UI) (not otherwise shown) for one implementation of the disclosed system for digitized contract generation with colocation security. Each screen shot is briefly described here and then further discussed below with respect to flow processes for FIGS. 4-6. Recall that roles may be assigned to users to assist in security and provide focus for specific users with respect to a state of a contract creation or update process. In some implementations, the life-cycle of a digital negotiation process may be implemented using one or more state machines to control flow of actions and contract sub-section content throughout the life-cycle. As is understood in the art, a state-machine may be visualized or implemented based on a directed graph where transitions (e.g., state changes) between nodes (e.g., nodes represent states) of the directed graph control a proper flow. That is, a directed graph may determine a restricted set of allowable transitions from one state to a next state because transitions are only allowed to occur between connected nodes.

FIG. 3A illustrates schematic 305 to depict that user 102 may access colocation 101 via gateway 107a upon presentation of proper credentials 130. FIG. 3B illustrates screen shot 310 which may represent an entry point into the disclosed system to initiate a new session for creation or update of an agreement. FIG. 3C illustrates screen shot 315 that informs the user of a state of a digital negotiation process (e.g., state of contract) at life-cycle status area 316 along with other information about the currently active contract (or sub-section thereof). FIG. 3D illustrates screen shot 320 including a “status” area 321 and a “my actions” area 322. Accordingly, screen shot 320 illustrates a UI screen where a user may receive a “dashboard” view of their current task list with respect to their role within the disclosed digital negotiation system. FIG. 3E illustrates screen shot 325 that includes a drop down 326 where a user can include products from a particular vendor to be included within a contract being created or adjusted. FIG. 3F illustrates screen shot 330 that provides a view of changes between a current document 331 and previous document 332 (e.g., the changed portions are highlighted for the user).

FIG. 3G illustrates screen shot 335 that includes a section name 336A, review name 336B, author 336C, and version 336D for a currently selected contract. Section selection area 338A indicates that a user may select different sections of a contract to interact with (e.g., based on their role and accessibility permissions). Approval history legend 338B provides a color coding that may be applied individually to each of the sub-sections available in selection section area 338A. History area 338C provides information about changes to a currently active subsection (e.g., that shown in current sub-section work area 338D). FIG. 3H illustrates screen shot 340 that includes section selection identification 341, section selection area 342A, approval history legend 342B, history 342C, and current sub-section work area 342D. FIG. 3I illustrates screen shot 345 that includes a role identification 347 (e.g., vendor signatory) and an entry area 346 for uploading a digital certificate file. FIG. 3J illustrates screen shot 350 that includes role identification area 351 (e.g., client signatory) and other information pertinent to a particular user having this role.

FIG. 4 shows an example process 400 for finalizing the approved contract. As shown in FIG. 4, after the user (client) 405 digitally signs the contract agreement 406, the contract is translated (using hash algorithm 407) to create a digital hash 408, and the signed digital contract 411 is associated with a private encryption key 409 and a designated vendor 410. Later, vendor 410 (e.g., a different user) may identify a previously signed contract 411 and use the public key 412 to decrypt and recreate digital hash 408. As this recreation process utilizes a public key associated with client 405, a comparison of hash 408 will determine if the hash 408 has been identically recreated (e.g., validated). In this example, because subsequent generation of the hash is identical contents of the document (previously signed contract 411) have not been tampered with. Once verified, vendor 410 may access digital signed contract 411 using private key 409 and apply a vendor's digital signature to the contract 411, thereby co-signing (on behalf of the vendor) the digital contract 411 (i.e., that was previously signed by client 405).

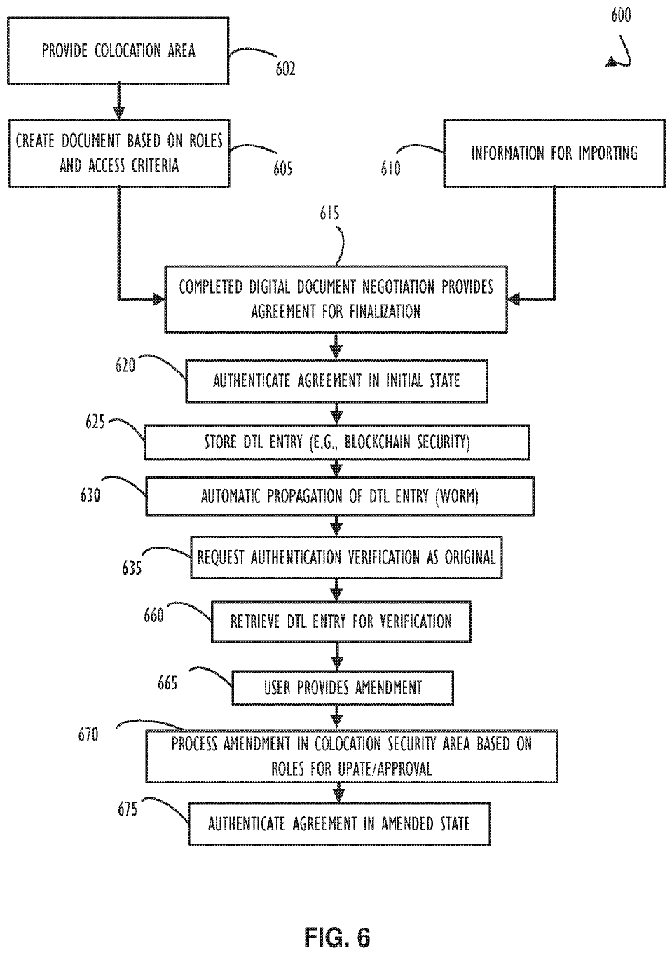

As discussed more below with reference to method 600 of FIG. 6, the signed contract may be secured after each digital signature, validating the digital signature based on user credentials (signature password and user password), allowing each of the users to confirm the signed contract, and thereby validating the users and the signed contract based on the contracting parameters. The approved contract may be validated by allowing each signature to be verified by the users and by the contact system. The approved contract may then be broadcast to the user validation nodes and to a system validation node via the transaction node (See FIG. 1). The transaction node may be used to notify the assigned users that the contract of a status change (e.g., a state transition within a state machine) indicating that the contract is approved. The user validation nodes may be activated to verify the users and/or the contract to assure that the contract is ready for validation. The system validation node may also be activated to verify, via the security node, that the credentials are valid. If the required number of user validation nodes and the system validation node approve (e.g., consensus is reached), the contract may be signed.

FIG. 5 shows an example process 500 for securing the contract and information therein throughout a digital negotiation process using, for example, blockchain. Securing may involve users (client 405, vendor 410, or an additional party 415) performing a user validation at the user nodes and system validation at the system nodes (e.g., as illustrated in FIG. 1). As shown in FIG. 5, after each signature is applied to the contract (or sub-section thereof), the signed contract may be sent to a transaction node 413 (also see 112a of FIG. 1), and broadcast to the user nodes and to the system node (also see 112c of FIG. 1). The users will have the opportunity via a transaction node 413 to access the contract 411 using the client public key 412 and confirm the parties and the contract. The users may either validate (e.g., perform user validation) or reject the contract via their respective transaction node 413. The user validation may involve confirming the parties and the terms. The disclosed contract system also has the ability to validate or invalidate the contract via the system node. The system validation may involve confirming user security credentials, such as such as signatures, passwords, etc., and system security credentials, such as timestamps, logs, public addresses, the digital fingerprint, etc. The contract system may confirm such security credentials properly correspond to the contract. After a consensus amongst a given number of validation nodes (e.g., about 50% or more) and the contract system node approves the contract, the digital contract is then validated and transitions into an approved state where it may become an active contract. After a period of time, amendments may be processed for any active contract to allow adjustment (e.g., add products or alter pricing) and each amendment may go through a similar creation/review/approve life-cycle prior to becoming active and augmenting/replacing the original contract.

FIG. 6 is a flow chart depicting an example method (600) of performing a digital negotiation process to generate and authenticate a digitized contract. At block 602 a colocation area (e.g., colocation 101 of FIG. 1) is provided either logically or physically within a computer network. The contract may be generated using the contract system to create a contract based on roles and access criteria as indicated at block 605. Block 610 indicates that information may be imported to facilitate contract generation. For example, information about product offerings from a vendor may be imported into the system for use in contract generation. Block 615 indicates that a completed digital document negotiation process may result in an agreement for finalization (e.g., signature by authorized parties based on their role). Method (600) includes block 620 where an agreement in its initial completed state (i.e., prior to possible amendment or future adjustment) may be authentication by providing the parties with access to the colocation area.

Block 630 indicates that the DTL may provide automatic propagation of each DTL entry in a write once read many (WORM) manner. DTL's such as blockchain allow new blocks in the chain to be created but never deleted or altered. Block 635 indicates that the completed contract (digital document) may be retrieved at a later time and an authentication request may be initiated to verify that the retrieved digital document is true and correct (e.g., a hash match as shown in FIG. 4). Block 660 indicates that a ledger entry may be retrieved from the DTL to perform the comparison. At this point, the information provided may be reviewed as the currently in force information.

Block 665 indicates that a user may initiate a process to amend the currently in force information (e.g., propose an amendment to the original or current contract). Block 670 indicates that the amendment may be processed in the colocation area in a similar manner to the processing of the original digital document negotiation (e.g., using roles, authentication, and validation). The amendment process may be approved and block 675 indicates that the amended document may become an authenticated agreement in an amended state to reflect the original agreement and modifications made as part of the amendment.

In summary, the process involves creating a draft contract at the contract colocation area based on contracting parameters received at the contract colocation from a first of the parties; allowing the parties to alter the draft contract at the colocation; finalizing the approved contract between the parties by applying a digital signature from each of the parties to the approved contract, and—securing the contract, in part, by using a DTL such as blockchain to authenticate the contract.

Providing the parties with access to the contract colocation may involve, for example, defining user credentials and roles for each of the parties, receiving user identification, and receiving user options. When a party first enters (e.g., connects remotely to) the contract system, each user is set up to use the contract system by passing through gateway providing security for colocation (e.g., as shown, for example, in FIG. 1). To do so, a user is registered for identification purposes, assigned user credentials for authentication, and associated with a role for each digital negotiation process. To register and/or authenticate, the user may enter user identification information, such as contact information, title, role, etc. The user may also enter user options for using the contract system by selecting options, such as screen setup, contact methods, etc. Optionally, this user information may be stored in the contract system and made available to other users.

User credentials may be created when each user is registered (defined within) with the contract colocation, and may include, for example, a password, a public key, a private key, and/or other security credentials (See FIG. 3A). Upon initial entry into the contract system, users register and define their user password. Each user is then assigned a public key and private key using the external key store (e.g., 129a as shown in FIG. 1). The public and private keys may be generated using encryption software that is either internal or external to a contract colocation. A private key may be generated (e.g., using ETHRIUM®) and assigned to the user and encrypted using, for example, a PKI and/or a certificate authority (CA). Security credentials (e.g., security credentials 130 of FIG. 1) for a user may be assigned and maintained by such user without being stored within the contact colocation. A combination of the security credentials, such as the password, public keys, and private keys may be used by the contract system to access and/or alter contracts in the contract colocation as is described further herein.

The draft contract is initially created at the colocation by defining certain contracting parameters, such as contracting party information, user roles, contract parameters, and contract terms. The draft contract may be formed from discrete sub-sections that together create a full digital document representing a contract The initial draft of the contract may be created by one of the parties, such as a vendor, or by a third party, such as a contracting service. The creating involves defining the parties to the contract, assigning user roles, defining contract parameters, importing vendor information, and selecting draft contract terms (write, import, and/or select pre-drafted terms). These contracting parameters may be stored in the colocation and accessed for future contracts.

The parties may be defined by entering party information, such as name, entity, state, address, affiliates, business partner selections, contact information. This information may be populated in portions of the draft contract, such as the preamble, signature block, etc. This information may be input by a user and/or edited/supplemented by another user as according to the access and permissions (e.g., role) provided to such users. The party information may be linked with registration information entered by the user and the security credentials associated with the user. Party information may be associated with and “linked” to each applicable contract. The parties may also be assigned party user roles to define which users have access to which contracts. Users may be assigned permissions to specify which contracts (or parts thereof) to make accessible. Users may be provided with alerts as to status changes (e.g., state transitions through a life-cycle) for such contracts. The assigned user roles may also be used to determine which users will take action on the contract. Select users may be assigned as originators, reviewers, editors, approvers, signatories, etc. The contract system may also send notices, alerts, request authorizations, and request approvals based on such assigned roles.

The contract parameters may be defined by inputting information about the contract to be formed, such as type of contract (e.g., manufacturing, purchase), dates, country, currency, description, etc. Additional information, such as affiliates, payment information, fees, etc. may also be defined. The contract and other contracting parameters may be input by a user, updated by one or more users, and/or selected from previous entries of record in the contract system. Examples of contracting parameters including contract type, title, start and end dates, location, customer entity, currency, and description (e.g., as shown in FIG. 3B).

The draft contract terms may be added to the contract by selecting terms from a pre-existing document or from the contract system. Example contract terms are depicted in FIG. 3C. The existing contracts and/or contract terms may be imported into the contract colocation by a user for use within the contract system. The user may also open a new draft contract within the colocation and select terms to add to the draft. The terms may be selected from those imported, or from those stored within the contract colocation. Various terms may be selected, such as price, delivery, obligations of the parties, warranties, indemnities, definitions, boilerplate language, and/or other terms and conditions. As also shown by FIG. 3C, the terms may be broken down into sections, such as header, definitions, requirements, pricing, payment terms, enrollment term, enrollment details, information, financing, etc. Such items may be searchable, and contract tags, such as affiliate, language, etc., can also be provided.

Once the contracting parameters are selected, the draft contract may be created. The draft contract may be populated with contracting parameters and assembled into a contract document accessible by select users. The party creating the initial draft of the contract may assemble the contract document and make change before submitting the contract to other users for review. The contract may be stored in the contract system (e.g., at the contract colocation), and accessed by the drafting party for future use.

Once created, the draft contract may be associated with the user and the user's credentials. Access to the contract may be restricted by requiring the user to present the security credentials (see, e.g., FIG. 3A) before the contract may be accessed as is described further herein. The draft contract may also be accessible at the contract colocation by authorized users defined according to their user roles.

The contract system may allow the parties to alter the draft contract at the colocation. The altering may involve notifying the parties according to the user roles of status changes to the draft contract (e.g., state changes associated with creation, revisions, comments, rejection, approval); allowing the parties to access the draft contract at the colocation according to their user roles and security credentials; receiving alterations from each of the parties; and upon approval of the draft contract by both parties, submitting the draft contract as an approved contract for signature.

The notifying actions described herein may include sending email notifications to those users that have been assigned one of the user roles which require notification. The user role may define the type, method, and timing of notification upon occurrence of a status change or triggering event, such as creation, revision, comment, rejection, approval or other action on the contract. For example, the designated users assigned to review, revise, approve, sign, or receive the contract will receive notifications. Such notifications may be alerts of certain activity on the contract, such as expiration, no action, requires review, approved, executed, etc. FIG. 3D shows an example screen with notifications that may be sent to the users. This example shows a status summary of contracts assigned to the user, together with actions completed by the user, internal fees showing actions by other users, and status alerts, such as contract expiring and my contract activity.

Allowing parties to access digital document information may involve allowing users to sign into the contract system and access the contract colocation using the various security credentials (e.g., security credentials 130 as shown in FIG. 3A). Such access to the contract is provided within the secure environment of the colocation, and its multi-layered security. To access specific contracts within the colocation, the user may be provided with access via a link, and/or specified passwords, keys, and/or other security credentials specific an individual contract.

Receiving alterations may involve allowing a user to review the draft contract (e.g., terms, remarks, comments, compare docs), enter alterations (e.g., revisions, comments) to the draft contract, submit the revised draft contract for additional internal/external review, and approve or reject the revised draft contract. The user may enter the contract to view only, make comments, change terms, etc. The revisions may be done by editing text, importing or adding terms, changing party information, adding users (e.g., reviewers, approvers, signatories, etc.) as previously described.

After each alteration, the contract may be submitted for review by other users of the same party, the other party, or other third parties. The process may repeat until no further alterations are requested. The process may also terminate when both parties approve, or one party finally rejects, the draft contract. FIGS. 3G and 3H shows screenshots of example approval pages for approving terms of the contract, and for viewing items to be approved, respectively. As shown in FIG. 3G, the terms may be separately viewed and selected for approval, and a history of review and approval shown. As shown in FIG. 3H a list of items for approval with certain terms accessible to view details of such terms may be presented to a user.

Upon approval of the draft contract by each party, the draft contract becomes an “approved contract”. The approval may require an acceptance of the document by one or more designated approvers of each of the parties. Once approved, the approved contract may be secured to prevent further alterations (e.g., via entries in a DTL). Permissions and/or authorizations may be defined to allow selective alterations after approval. Upon approval, the approved contract may be submitted for final signature.

The approved contract may be finalized and signed by applying a digital signature from each of the parties to the approved contract. The finalizing may involve notifying the first of the parties to sign the approved contract, applying a digital signature of the first party to the approved contract, and linking the digital signature of the first party to the public key of the first party, translating the contract into a digital fingerprint (e.g., hash), storing the digital fingerprint in the contract colocation, verifying the first digital signature, and upon verification of the first digital signature, applying a second digital signature of a second party to the approved contract (e.g., co-signing).

The first digital signature may be applied after notifying a first of the parties to sign the approved contract, receiving the digital signature of the first party, and linking the digital signature of the first party to the public key of the first party. Next, the designated user of the first party receives a notifier alerting the first party that the approved contract is available for signature. The designated user of the first party may log into the contract colocation using a password to access the approved contract. Upon accessing the contract, the designated user of the first party receives a prompt to digitally sign the contract. The first party digital signature may be applied by accessing the external signature store (See 129b of FIG. 1), verifying security credentials, and applying a secure signature using the digital facilities of the external signature store. The signature may be maintained externally through the external signature store. FIG. 3I shows an example digital signature page showing a digital signature for upload by a user that is acting as the vendor signatory.

Next, the first digital signature may be verified and then a second digital signature of a second party to the approved contract is applied. Once the digital signature of the first party user is applied to the approved contract, the second party may be notified that the approved contract is signed and available for signature by the second party. The second digital signature may be applied by notifying the designated user of the second party to co-sign the signed contract, decrypting the digital signature of the first party with the public key, and receiving the second digital signature of the second party. When the approved contract is accessed, the second party may see the first party's digital signature applied to the contract.

The digital signature of the first party on the approved contract may give the second party reason to believe the message was created by a known sender. FIG. 3J shows an example of the security linked to the signing user (client signatory). FIG. 3J shows example security credentials for the user/vendor signatory, including personal details as well as password and digital certificate. Because the second party also has access to the first party's public key within the contract colocation, the second party may access the signed contract using the first party's public key. The first party's public key may be linked to the digital signature such that the signed contract cannot be accessed unless the public key is able to decrypt the first party's digital signature. If the public key is unable to do so, the signed contract is not accessible. If the signed contract is the incorrect contract, or the signed contract has been updated since it was signed, the public key may be set to no longer work. Once the second party confirms the identity of the first party, and can verify the digital signature on the contract, the second party may digitally countersign the contract using the same digital signature process.

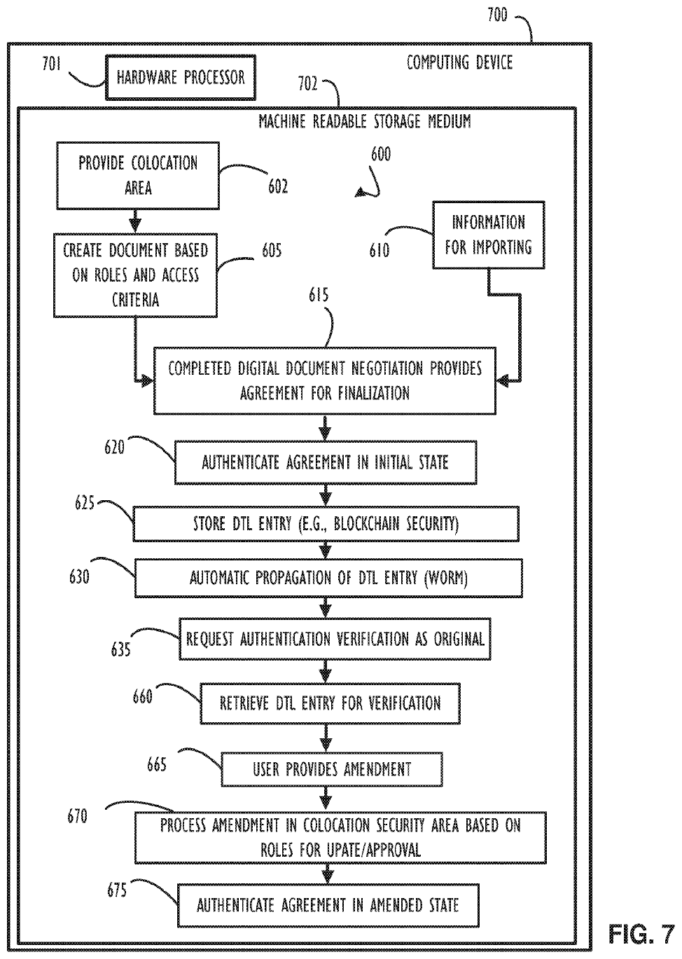

Referring now to FIG. 7, shown is an example computing device 700, with a hardware processor 701, and accessible machine-readable instructions stored on a machine-readable medium 702 that may be used to implement the system for creating and managing digital documents, according to one or more disclosed example implementations. FIG. 7 illustrates computing device 700 configured to perform the flow of method 600 as an example. However, computing device 700 may also be configured to perform the flow of other methods, techniques, functions, or processes described in this disclosure. In this example of FIG. 7, machine-readable storage medium 702 includes instructions to cause hardware processor 701 to perform blocks 602*675 discussed above with reference to FIG. 6.

A machine-readable storage medium, such as 702 of FIG. 7, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (“EPROM”), random access memory (“RAM”), non-volatile random access memory (“NVRAM”), optical disk, solid state drive (“SSD”), flash memory chips, and the like. The machine-readable storage medium may be a non-transitory storage medium, where the term “non-transitory” does not encompass transitory propagating signals.

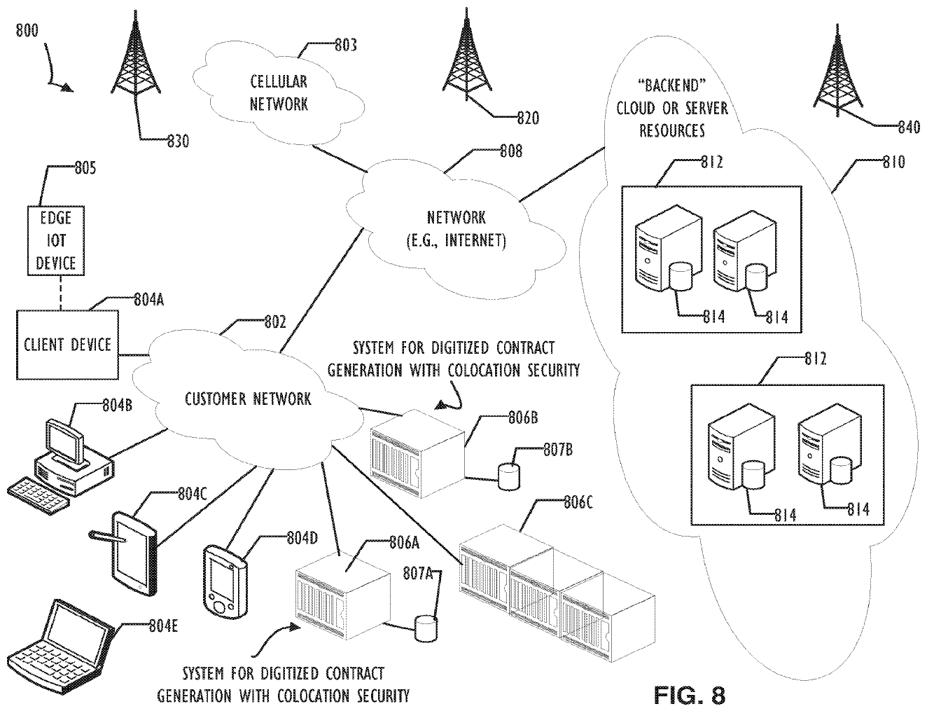

FIG. 8 represents a computer network infrastructure 800 that may be used to implement all or part of the disclosed system for creating and managing digital contracts using a colocation, according to one or more disclosed implementations. Network infrastructure 800 includes a set of networks where implementations of the present disclosure may operate in one or more of the different networks. Network infrastructure 800 comprises a customer network 802, network 808, cellular network 803, and a cloud service provider network 810. In one implementation, the customer network 802 may be a local private network, such as local area network (“LAN”) that includes a variety of network devices that include, but are not limited to switches, servers, and routers.

Each of these networks may contain wired or wireless programmable devices and operate using any number of network protocols (e.g., TCP/IP) and connection technologies (e.g., WiFi® networks, or Bluetooth®. In another implementation, customer network 802 represents an enterprise network that could include or be communicatively coupled to one or more local area networks (“LANs”), virtual networks, data centers and/or other remote networks (e.g., 808, 810). In the context of the present disclosure, customer network 802 may include one or more high-availability switches or network devices using methods and techniques such as those described above (e.g., a system for digitized contract generation with colocation security, in part, using compute-resource 806A and compute-resource 806B).

As shown in FIG. 8, customer network 802 may be connected to one or more client devices 804A-E and allow the client devices 804A-E to communicate with each other and/or with cloud service provider network 810, via network 808 (e.g., Internet). Client devices 804A-E may be computing systems such as desktop computer 804B, tablet computer 804C, mobile phone 804D, laptop computer (shown as wireless) 804E, and/or other types of computing systems generically shown as client device 804A.

Network infrastructure 800 may also include other types of devices generally referred to as Internet of Things (“IoT”) (e.g., edge IOT device 805) that may be configured to send and receive information via a network to access cloud computing services or interact with a remote web browser application (e.g., to receive configuration information).

FIG. 8 also illustrates that customer network 802 includes local compute resources 806A-C that may include a server, access point, router, or other device configured to provide for local computational resources and/or facilitate communication amongst networks and devices. For example, local compute resources 806A-C may be one or more physical local hardware devices, such as the auto-mode network infrastructure devices outlined above. Local compute resources 806A-C may also facilitate communication between other external applications, data sources (e.g., 807A and 807B), and services, and customer network 802.

Network infrastructure 800 also includes cellular network 803 for use with mobile communication devices. Mobile cellular networks support mobile phones and many other types of mobile devices such as laptops etc. Mobile devices in network infrastructure 600 are illustrated as mobile phone 804D, laptop computer 804E, and tablet computer 804C. A mobile device such as mobile phone 804D may interact with one or more mobile provider networks as the mobile device moves, typically interacting with a plurality of mobile network towers 8620, 830, and 840 for connecting to the cellular network 803.

In FIG. 8, cloud service provider network 810 is illustrated as a remote network (e.g., a cloud network) that is able to communicate with client devices 804A-E via customer network 802 and network 808. The cloud service provider network 810 acts as a platform that provides additional computing resources to the client devices 804A-E and/or customer network 802. In one implementation, cloud service provider network 810 includes one or more data centers 812 with one or more server instances 814. Cloud service provider network 810 may also include one or more frames or clusters (and cluster groups) representing a scalable compute resource that may implement the techniques of this disclosure. Specifically, disclosed techniques involve DTL transactions that may be implemented using a cloud-based system for different functional components.

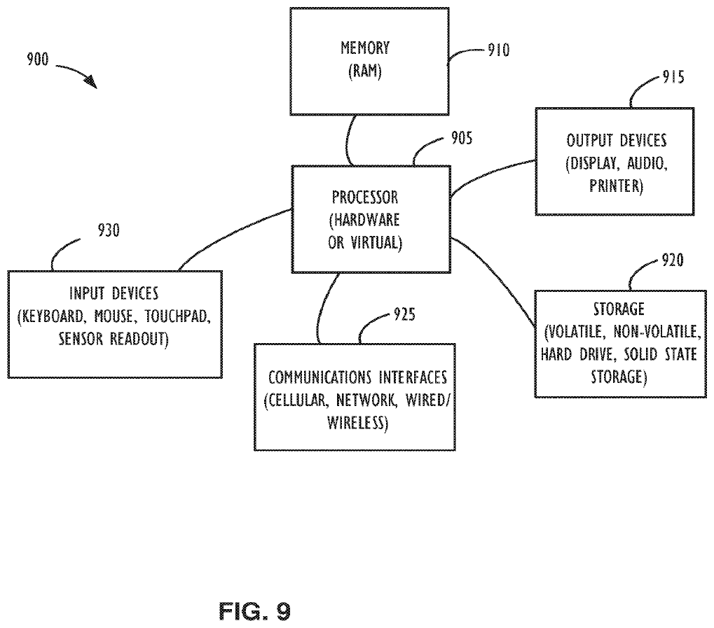

FIG. 9 illustrates a computing device 900 that may be used to implement or be used with the functions, modules, processing platforms, execution platforms, communication devices, and other methods and processes of this disclosure. For example, computing device 900 illustrated in FIG. 9 could represent a client device or a physical server device and include either hardware or virtual processor(s) depending on the level of abstraction of the computing device. In some instances (without abstraction), computing device 900 and its elements, as shown in FIG. 9, each relate to physical hardware. Alternatively, in some instances one, more, or all of the elements could be implemented using emulators or virtual machines as levels of abstraction. In any case, no matter how many levels of abstraction away from the physical hardware, computing device 900 at its lowest level may be implemented on physical hardware.

As also shown in FIG. 9, computing device 900 may include one or more input devices 930, such as a keyboard, mouse, touchpad, or sensor readout (e.g., biometric scanner) and one or more output devices 915, such as displays, speakers for audio, or printers. Some devices may be configured as input/output devices also (e.g., a network interface or touchscreen display).

Computing device 900 may also include communications interfaces 925, such as a network communication unit that could include a wired communication component and/or a wireless communications component, which may be communicatively coupled to processor 905. The network communication unit may utilize any of a variety of proprietary or standardized network protocols, such as Ethernet, TCP/IP, to name a few of many protocols, to effect communications between devices. Network communication units may also comprise one or more transceiver(s) that utilize the Ethernet, power line communication (“PLC”), WiFi®, cellular, and/or other communication methods.

As illustrated in FIG. 9, computing device 900 includes a processing element such as processor 905 that contains one or more hardware processors, where each hardware processor may have a single or multiple processor core. 9 Although not illustrated in FIG. 9, the processing elements that make up processor 905 may also include one or more of other types of hardware processing components, such as graphics processing units (“GPU”), application specific integrated circuits (“ASICs”), field-programmable gate arrays (“FPGAs”), and/or digital signal processors (“DSPs”).

FIG. 9 illustrates that memory 910 may be operatively and communicatively coupled to processor 905. Memory 910 may be a non-transitory medium configured to store various types of data. For example, memory 910 may include one or more storage devices 920 that comprise a non-volatile storage device and/or volatile memory. Volatile memory, such as random-access memory (“RAM”), can be any suitable non-permanent storage device. The non-volatile storage devices 920 can include one or more disk drives, optical drives, solid-state drives (“SSDs”), tap drives, flash memory, read only memory (“ROM”), and/or any other type of memory designed to maintain data for a duration of time after a power loss or shut down operation. In certain instances, the non-volatile storage devices 920 may be used to store overflow data if allocated RAM is not large enough to hold all working data. The non-volatile storage devices 920 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 905. In one implementation, the compiling process of the software program may transform program code written in a programming language to another computer language such that the processor 905 is able to execute the programming code. After the compiling process, the encoded instructions may then be loaded as computer executable instructions or process steps to processor 905 from storage device 920, from memory 910, and/or embedded within processor 905 (e.g., via a cache or on-board ROM). Processor 905 may be configured to execute the stored instructions or process steps in order to perform instructions or process steps to transform the computing device into a non-generic, particular, specially programmed machine or apparatus. Stored data, e.g., data stored by a storage device 920, may be accessed by processor 905 during the execution of computer executable instructions or process steps to instruct one or more components within the computing device 900.

A user interface (e.g., output devices 915 and input devices 930) can include a display, positional input device (such as a mouse, touchpad, touchscreen, or the like), keyboard, or other forms of user input and output devices. The user interface components may be communicatively coupled to processor 905.

Various parts of the method 600 may be repeated as needed. One or more portions of the method may be performed simultaneously or in any order as needed.

While the embodiments are described with reference to various implementations and exploitations, it will be understood that these embodiments are illustrative and that the scope of the inventive subject matter is not limited to them. Many variations, modifications, additions and improvements are possible. For example, various combinations of one or more of the features herein may be provided about for one or more parties and/or users, using a variety of contracting parameters, and performed in various combinations and sequences.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

Insofar as the description above and the accompanying drawings disclose any additional subject matter that is not within the scope of the claim(s) herein, the inventions are not dedicated to the public and the right to file one or more applications to claim such additional invention is reserved. Although a very narrow claim may be presented herein, it should be recognized the scope of this invention is much broader than presented by the claim(s). Broader claims may be submitted in an application that claims the benefit of priority from this application.

1. A computer-based document management system (“DMS”) to facilitate a digital negotiation process for a digital document based on management of subsections of that document, the system comprising one or more computer processors configured to execute instructions to cause the one or more computer processors to:
provide a colocation area concurrently accessible to multiple users including a first user and a second user, each of the multiple users having a different role-based access to the colocation area;
manage a plurality of subsections of a single digital document based on an associated subsection life-cycle, the single digital document further having a document life-cycle different from any subsection life-cycle;
authenticate access for the first user to a first subset of the plurality of subsections based on a first role associated with the first user and security credentials of the first user;
authenticate access for the second user to a second subset of the plurality of subsections, different from the first subset, the authentication based on a second role different from the first role, the authentication associated with the second user and security credentials of the second user;
allow alteration, by the first user or the second user, to accessible subsections based on a current state within respective life-cycles for each subsection subject to alteration;
determine all of the plurality of subsections have completed each respective subsection life-cycle to progress the single digital document to a signature state of the document life-cycle;
receive a first sign-off on the single digital document in the signature state from a first party associated with the first user and a second sign-off from a second party associated with the second user to complete the document life-cycle; and
store an indication of the received first sign-off and the second sign-off in a distributed transaction ledger to reflect that the single digital document becomes a signed digital document.

2. The DMS of claim 1, wherein the distributed transaction ledger is implemented using blockchain.

3. The DMS of claim 1, wherein the one or more computer processors are further configured to execute instructions to cause the one or more computer processors to:
prevent access for the second user to a portion of the first subset of the plurality of subsections based on the second role and the portion associated with a non-completed subsection life-cycle, wherein subsections that are not finished with their respective subsection life-cycle maintain restricted access and subsections that are finished are provided as read-only.

4. The DMS of claim 1, wherein the plurality of subsections are maintained as digital files within the colocation area.

5. The DMS of claim 4, wherein the colocation area is a physically segregated computer storage area.

6. The DMS of claim 4, wherein the colocation area comprises a group of separate computer storage areas logically related to each other.

7. The DMS of claim 1, wherein at least one subsection life-cycle is implemented as a directed graph.

8. The DMS of claim 1, wherein the document life-cycle is implemented as a directed graph.

9. The DMS of claim 1, wherein the first user is a vendor, the second user is a client, and the single digital document represents a software license agreement.

10. The DMS of claim 9, wherein the one or more computer processors are further configured to execute instructions to cause the one or more computer processors to:
provide an import interface to the vendor to import structured information representing software product offerings applicable to the software license agreement.

11. The DMS of claim 9, wherein the one or more computer processors are further configured to execute instructions to cause the one or more computer processors to:
provide an import interface to the client to import structured information representing software product usage collected from execution of software application within a client network.

12. The DMS of claim 1, wherein the first role and the second role are selected from the group of roles consisting of: Client Author, Client Reviewer, Client Signatory, Vendor Author, Vendor Reviewer, and Vendor Signatory.

13. The DMS of claim 1, wherein the one or more computer processors are further configured to execute instructions to cause the one or more computer processors to:
receive an indication of an update from either the first user or the second user with respect to an amendment to the signed digital document; and
provide a secured access to the colocation area to process the amendment through any associated subsection life-cycle impacted by the amendment to complete the associated subsection life-cycles and progress the signed digital document to the signature state after implementing the amendment.

14. A non-transitory machine-readable storage medium comprising instructions, that, when executed, cause a processing resource to:
provide a colocation area concurrently accessible to multiple users including a first user and a second user, each of the multiple users having a different role-based access to the colocation area;
manage a plurality of subsections of a single digital document based on an associated subsection life-cycle, the single digital document further having a document life-cycle different from any subsection life-cycle;
authenticate access for the first user to a first subset of the plurality of subsections based on a first role associated with the first user and security credentials of the first user;
authenticate access for the second user to a second subset of the plurality of subsections, different from the first subset, the authentication based on a second role different from the first role, the authentication associated with the second user and security credentials of the second user;
allow alteration, by the first user or the second user, to accessible subsections based on a current state within respective life-cycles for each subsection subject to alteration;
determine all of the plurality of subsections have completed each respective subsection life-cycle to progress the single digital document to a signature state of the document life-cycle;
receive a first sign-off on the single digital document in the signature state from a first party associated with the first user and a second sign-off from a second party associated with the second user to complete the document life-cycle; and
store an indication of the received first sign-off and the second sign-off in a distributed transaction ledger to reflect that the single digital document becomes a signed digital document.

15. The non-transitory machine-readable storage medium of claim 14, further comprising instructions, that, when executed, cause the processing resource to:
receive an indication of update from either the first user or the second user with respect to an amendment to the signed digital document; and
provide secured access to the colocation to process the amendment through any associated subsection life-cycles impacted by the amendment to complete the associated subsection life-cycles and progress the digital document to the signature state after implementing the amendment.

16. A document management system, comprising:
one or more computer processors;
a computer storage;
a digital document comprising a plurality of subsections, the digital document residing in the computer storage as a plurality of digital files, each file constituting a respective one of the subsections;
a set of instructions residing in the computer storage that, when executed by the one or more processors, causes the one or more processors to:
manage each of the subsections through a respective subsection life-cycle and the digital document through a document life-cycle;
permit at least one of a first authenticated user to alter a first subsection or a second authenticated user to alter a second subsection depending on a current state of the first subsection or the second subsection life-cycle as a part of the managing, the altering progressing the first subsection or the second subsection through the respective subsection life-cycle;
receive a first sign-off on behalf of the first authenticated user and a second signoff on behalf of the second authenticated user to complete the document life-cycle; and
store an indication of the completion of the document life-cycle in a distributed transaction ledger.
